(19) United States
(12) Patent Application Publication
(10) Pub. No.: US 2021/0058914 A1
(43) Pub. Date: Feb. 25, 2021

(54) METHOD FOR TRANSMITTING/RECEIVING SYNCHRONOUS BEAM DISCOVERY SIGNAL FOR DEVICE-TO-DEVICE COMMUNICATION IN WIRELESS COMMUNICATION SYSTEM

(71) Applicant: LG Electronics Inc., Seoul (KR)

(72) Inventors: Hyukjin CHAE, Seoul (KR); Sunghoon JUNG, Seoul (KR)

(21) Appl. No.: 16/981,133

(22) PCT Filed: Apr. 15, 2019
(86) PCT No.: PCT/KR2019/004498

§ 371 Date: Sep. 15, 2020

(30) Foreign Application Priority Data
Apr. 13, 2018 (KR) 10-2018-0043006

(51) Int. Cl. H04W 72/04; H04W 16/28

(52) U.S. Cl. CPC H04W 72/046; H04W 92/18; H04W 16/28

(57) ABSTRACT

A method by which a terminal transmits a beam discovery signal in a wireless communication system includes: allowing a first terminal having acquired a sidelink synchronization to select a beam discovery resource from a beam discovery resource pool; and transmitting the beam discovery signal by using the beam discovery resource, wherein the selected beam discovery resource is different from the beam discovery resource selected by a second terminal. The UE is capable of communicating with at least one of another UE, a UE related to an autonomous driving vehicle, a base station or a network.

### TECHNICAL FIELD

The present disclosure relates to a wireless communication system and, more particularly, to a method and apparatus for efficiently discovering a beam in device-to-device (D2D) communication.

### BACKGROUND ART

As a number of communication devices have required higher communication capacity, the necessity for mobile broadband communication enhanced than the legacy radio access technology (RAT) has increased. In addition, massive machine type communications (MTC) capable of providing various services anytime and anywhere by connecting a number of devices or things to each other has also been considered in next-generation communication systems. Moreover, a communication system design capable of supporting services/user equipments (UEs) sensitive to reliability and latency has been discussed. That is, the introduction of a next generation RAT considering enhanced mobile broadband communication (eMBB), massive MTC (mMTC), ultra-reliable and low-latency communication (URLLC), etc. has been discussed. In the present disclosure, the corresponding technology is referred to as ‘new radio (NR)’. NR is one of fifth-generation (5G) RATs.

In a new RAT system including NR, an orthogonal frequency-division multiplexing (OFDM) transmission scheme or a transmission scheme similar thereto is used. The new RAT system may use OFDM parameters different from those of long term evolution (LTE). The new RAT system may follow the numerology of legacy LTE/LTE-Advanced (LTE-A) or have a wider system bandwidth (e.g., 100 MHz). A plurality of numerologies may be supported in one cell. In other words, UEs operating with different numerologies may coexist in one cell.

### DISCLOSURE

### Technical Problem

The object of the present disclosure is to provide a method of transmitting and receiving a beam discovery signal based on a beam discovery resource in device-to-device (D2D) communication.

It will be appreciated by persons skilled in the art that the objects that could be achieved with the present disclosure are not limited to what has been particularly described hereinabove and the above and other objects that the present disclosure could achieve will be more clearly understood from the following detailed description.

### Technical Solution

In one aspect of the present disclosure, a method of transmitting a beam discovery signal by a user equipment (UE) in a wireless communication system is provided. The method may include: selecting, by a first UE obtaining sidelink synchronization, a beam discovery resource from a beam discovery resource pool; and transmitting the beam discovery signal on the selected beam discovery resource, wherein the selected beam discovery resource may be different from a beam discovery resource selected by a second UE.

In another aspect of the present disclosure, a method of receiving a beam discovery signal by a user equipment (UE) in a wireless communication system is provided. The method may include: selecting, by a first UE obtaining sidelink synchronization, a beam discovery resource from a beam discovery resource pool; and receiving the beam discovery signal on the selected beam discovery resource, wherein the selected beam discovery resource may be different from a beam discovery resource selected by a second UE.

In a further aspect of the present disclosure, a first user equipment (UE) device for transmitting a beam discovery signal in a wireless communication system is provided. The first UE device may include: a transceiver; and a processor configured to control the transceiver, wherein the processor may be configured to: control the first UE obtaining sidelink synchronization to select a beam discovery resource from a beam discovery resource pool; and transmit the beam discovery signal on the selected beam discovery resource, and wherein the selected beam discovery resource may be different from a beam discovery resource selected by a second UE.

To select the beam discovery resource, the UE may select one beam discovery resource from among a plurality of beam discovery resources or receive signaling indicating the beam discovery resource from a base station.

The beam discovery signal may be transmitted in the directions according to the beam discovery resource in the order of the directions.

The beam discovery resource may include a plurality of consecutive beam resources, the plurality of beam resources may not overlap with each other in the time domain, and a beam transmission direction may be allocated to each of the plurality of beam resources.

The first and second UEs may belong to different zones. The beam transmission direction allocated to each of the plurality of beam resources may vary for each zone.

The beam discovery signal may be transmitted on a beam resource among the plurality of beam resources.

The directions according to the beam discovery resource may be determined with respect to cardinal directions or the moving direction of the UE.

The beam discovery resource may be configured to be hopped in the beam discovery resource pool. The beam discovery resource may be hopped in the same way as hopping on a control channel

The beam discovery resource pool may be configured with a period determined by a base station depending on a state of the UE.

### Advantageous Effects

According to the present disclosure, overhead caused by beam search in device-to-device (D2D) communication may be efficiently reduced.

It will be appreciated by persons skilled in the art that the effects that could be achieved with the present disclosure are not limited to what has been particularly described hereinabove and other advantages of the present disclosure will be more clearly understood from the following detailed description.

### DESCRIPTION OF DRAWINGS

The accompanying drawings, which are included to provide a further understanding of the present disclosure and are incorporated in and constitute a part of this application, illustrate embodiments of the present disclosure and together with the description serve to explain the principle of the present disclosure.

FIG. 1 illustrates a frame structure in new radio (NR).

FIG. 2 illustrates a resource grid in NR.

FIG. 3 illustrates sidelink synchronization

FIG. 4 illustrates a time resource unit for transmitting a sidelink synchronization signal.

FIG. 5 illustrates a sidelink resource pool.

FIG. 6 illustrates scheduling schemes based on transmission modes.

FIG. 7 illustrates selection of sidelink transmission resources.

FIG. 8 illustrates transmission of a physical sidelink control channel (PSCCH).

FIG. 9 illustrates PSCCH transmission in sidelink vehicle-to-everything (V2X) communication.

FIG. 10 illustrates the configuration of a beam discovery resource pool and beam discovery signal transmission at a user equipment (UE) according to the present disclosure.

FIG. 11 illustrates an example in which a beam discovery resource is transmitted in each different zone according to the present disclosure.

FIG. 12 is a flowchart for explaining an embodiment of the present disclosure.

FIG. 13 is a block diagram illustrating devices according to the present disclosure.

### BEST MODE

In this document, downlink (DL) communication refers to communication from a base station (BS) to a user equipment (UE), and uplink (UL) communication refers to communication from the UE to the BS. In DL, a transmitter may be a part of the BS and a receiver may be a part of the UE. In UL, a transmitter may be a part of the UE and a receiver may be a part of the BS. Herein, the BS may be referred to as a first communication device, and the UE may be referred to as a second communication device. The term ‘BS’ may be replaced with ‘fixed station’, ‘Node B’, ‘evolved Node B (eNB)’, ‘next-generation node B (gNB)’, ‘base transceiver system (BTS)’, ‘access point (AP)’, ‘network node’, ‘fifth-generation (5G) network node’, ‘artificial intelligence (AI) system’, ‘road side unit (RSU)’, ‘robot’, etc. The term ‘UE’ may be replaced with ‘terminal’, ‘mobile station (MS)’, ‘user terminal (UT)’, ‘mobile subscriber station (MSS)’, ‘subscriber station (SS)’, ‘advanced mobile station (AMS)’, ‘wireless terminal (WT)’, ‘machine type communication (MTC) device’, ‘machine-to-machine (M2M) device’, ‘device-to-device (D2D) device’, ‘vehicle’, ‘robot’, ‘AI module’, etc.

The technology described herein is applicable to various wireless access systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA may be implemented as radio technology such as universal terrestrial radio access (UTRA) or CDMA2000. The TDMA may be implemented as radio technology such as global system for mobile communications (GSM), general packet radio service (GPRS), or enhanced data rates for GSM evolution (EDGE). The OFDMA may be implemented as radio technology such as the Institute of Electrical and Electronics Engineers (IEEE) 802.11 (Wi-Fi), IEEE 802.16 (WiMAX), IEEE 802-20, evolved UTRA (E-UTRA), etc. The UTRA is a part of a universal mobile telecommunication system (UMTS). 3rd generation partnership project (3GPP) long term evolution (LTE) is a part of evolved UMTS (E-UMTS) using E-UTRA. LTE-advance (LTE-A) or LTE-A pro is an evolved version of 3GPP LTE. 3GPP new radio or new radio access technology (3GPP NR) is an evolved version of 3GPP LTE, LTE-A, or LTE-A pro.

Although the present disclosure is described based on 3GPP communication systems (e.g., LTE-A, NR, etc.) for clarity of description, the spirit of the present disclosure is not limited thereto. LTE refers to technologies beyond 3GPP technical specification (TS) 36.xxx Release 8. In particular, LTE technologies beyond 3GPP TS 36.xxx Release 10 are referred to as LTE-A, and LTE technologies beyond 3GPP TS 36.xxx Release 13 are referred to as LTE-A pro. 3GPP NR refers to technologies beyond 3GPP TS 38.xxx Release 15. LTE/NR may be called ‘3GPP system’. Herein, “xxx” refers to a standard specification number.

In the present disclosure, a node refers to a fixed point capable of transmitting/receiving a radio signal for communication with a UE. Various types of BSs may be used as the node regardless of the names thereof. For example, the node may include a BS, a node B (NB), an eNB, a pico-cell eNB (PeNB), a home eNB (HeNB), a relay, a repeater, etc. A device other than the BS may be the node. For example, a radio remote head (RRH) or a radio remote unit (RRU) may be the node. The RRH or RRU generally has a lower power level than that of the BS. At least one antenna is installed for each node. The antenna may refer to a physical antenna or mean an antenna port, a virtual antenna, or an antenna group. The node may also be referred to as a point.

In the present disclosure, a cell refers to a prescribed geographical area in which one or more nodes provide communication services or a radio resource. When a cell refers to a geographical area, the cell may be understood as the coverage of a node where the node is capable of providing services using carriers. When a cell refers to a radio resource, the cell may be related to a bandwidth (BW), i.e., a frequency range configured for carriers. Since DL coverage, a range within which the node is capable of transmitting a valid signal, and UL coverage, a range within which the node is capable of receiving a valid signal from the UE, depend on carriers carrying the corresponding signals, the coverage of the node may be related to the coverage of the cell, i.e., radio resource used by the node. Accordingly, the term “cell” may be used to indicate the service coverage of a node, a radio resource, or a range to which a signal transmitted on a radio resource can reach with valid strength.

In the present disclosure, communication with a specific cell may mean communication with a BS or node that provides communication services to the specific cell. In addition, a DL/UL signal in the specific cell refers to a DL/UL signal from/to the BS or node that provides communication services to the specific cell. In particular, a cell providing DL/UL communication services to a UE may be called a serving cell. The channel state/quality of the specific cell may refer to the channel state/quality of a communication link formed between the BS or node, which provides communication services to the specific cell, and the UE.

When a cell is related to a radio resource, the cell may be defined as a combination of DL and UL resources, i.e., a combination of DL and UL component carriers (CCs). The cell may be configured to include only DL resources or a combination of DL and UL resources. When carrier aggregation is supported, a linkage between the carrier frequency of a DL resource (or DL CC) and the carrier frequency of a UL resource (or UL CC) may be indicated by system information transmitted on a corresponding cell. The carrier frequency may be equal to or different from the center frequency of each cell or CC. A cell operating on a primary frequency may be referred to as a primary cell (Pcell) or PCC, and a cell operating on a secondary frequency may be referred to as a secondary cell (Scell) or SCC. The Scell may be configured after the UE and BS establish a radio resource control (RRC) connection therebetween by performing an RRC connection establishment procedure, that is, after the UE enters the RRC CONNECTED state. The RRC connection may mean a path that enables the RRC of the UE and the RRC of the BS to exchange an RRC message. The Scell may be configured to provide additional radio resources to the UE. The Scell and the Pcell may form a set of serving cells for the UE depending on the capabilities of the UE. When the UE is not configured with carrier aggregation or does not support the carrier aggregation although the UE is in the RRC CONNECTED state, only one serving cell configured with the Pcell exists.

A cell supports a unique radio access technology (RAT). For example, transmission/reception in an LTE cell is performed based on the LTE RAT, and transmission/reception in a 5G cell is performed based on the 5G RAT.

The carrier aggregation is a technology for combining a plurality of carriers each having a system BW smaller than a target BW to support broadband. The carrier aggregation is different from OFDMA in that in the former, DL or UL communication is performed on a plurality of carrier frequencies each forming a system BW (or channel BW) and in the latter, DL or UL communication is performed by dividing a base frequency band into a plurality of orthogonal subcarriers and loading the subcarriers in one carrier frequency. For example, in OFDMA or orthogonal frequency division multiplexing (OFDM), one frequency band with a predetermined system BW is divided into a plurality of subcarriers with a predetermined subcarrier spacing, and information/data is mapped to the plurality of subcarriers. Frequency up-conversion is applied to the frequency band to which the information/data is mapped, and the information/data is transmitted on the carrier frequency in the frequency band. In wireless carrier aggregation, multiple frequency bands, each of which has its own system BW and carrier frequency, may be simultaneously used for communication, and each frequency band used in the carrier aggregation may be divided into a plurality of subcarriers with a predetermined subcarrier spacing.

3GPP communication specifications define DL physical channels corresponding to resource elements carrying information originating from higher (upper) layers of physical layers (e.g., a medium access control (MAC) layer, a radio link control (RLC) layer, a protocol data convergence protocol (PDCP) layer, an RRC layer, a service data adaptation protocol (SDAP) layer, a non-access stratum (NAS) layer, etc.) and DL physical signals corresponding to resource elements which are used by physical layers but do not carry information originating from higher layers. For example, a physical downlink shared channel (PDSCH), a physical broadcast channel (PBCH), a physical multicast channel (PMCH), a physical control format indicator channel (PCFICH), and a physical downlink control channel (PDCCH) are defined as the DL physical channels, and a reference signal and a synchronization signal are defined as the DL physical signals. A reference signal (RS), which is called a pilot signal, refers to a predefined signal with a specific waveform known to both the BS and UE. For example, a cell-specific RS (CRS), a UE-specific RS (UE-RS), a positioning RS (PRS), a channel state information RS (CSI-RS), and a demodulation reference signal (DMRS) may be defined as DL RSs. In addition, the 3GPP communication specifications define UL physical channels corresponding to resource elements carrying information originating from higher layers and UL physical signals corresponding to resource elements which are used by physical layers but do not carry information originating from higher layers. For example, a physical uplink shared channel (PUSCH), a physical uplink control channel (PUCCH), and a physical random access channel (PRACH) are defined as the UL physical channels, and a demodulation reference signal (DMRS) for a UL control/data signal and a sounding reference signal (SRS) used for UL channel measurement are defined as the UL physical signals.

In the present disclosure, the PDCCH and the PDSCH may refer to a set of time-frequency resources or resource elements carrying downlink control information (DCI) of the physical layer and a set of time-frequency resources or resource elements carrying DL data thereof, respectively. The PUCCH, the PUSCH, and the PRACH may refer to a set of time-frequency resources or resource elements carrying uplink control information (UCI) of the physical layer, a set of time-frequency resources or resource elements carrying UL data thereof, and a set of time-frequency resources or resource elements carrying random access signals thereof, respectively. When it is said that a UE transmits a UL physical channel (e.g., PUCCH, PUSCH, PRACH, etc.), it may mean that the UE transmits DCI, UL data, or a random access signal on or over the corresponding UL physical channel. When it is said that the BS receives a UL physical channel, it may mean that the BS receives DCI, UL data, a random access signal on or over the corresponding UL physical channel. When it is said that the BS transmits a DL physical channel (e.g., PDCCH, PDSCH, etc.), it may mean that the BS transmits DCI or UL data on or over the corresponding DL physical channel. When it is said that the UE receives a DL physical channel, it may mean that the UE receives DCI or UL data on or over the corresponding DL physical channel.

In the present disclosure, a transport block may mean the payload for the physical layer. For example, data provided from the higher layer or MAC layer to the physical layer may be referred to as the transport block.

In the present disclosure, hybrid automatic repeat request (HARQ) may mean a method used for error control. A HARQ acknowledgement (HARQ-ACK) transmitted in DL is used to control an error for UL data, and a HARQ-ACK transmitted in UL is used to control an error for DL data. A transmitter that performs the HARQ operation waits for an ACK signal after transmitting data (e.g. transport blocks or codewords). A receiver that performs the HARQ operation transmits an ACK signal only when the receiver correctly receives data. If there is an error in the received data, the receiver transmits a negative ACK (NACK) signal. Upon receiving the ACK signal, the transmitter may transmit (new) data but, upon receiving the NACK signal, the transmitter may retransmit the data. Meanwhile, there may be a time delay until the BS receives ACK/NACK from the UE and retransmits data after transmitting scheduling information and data according to the scheduling information. The time delay occurs due to a channel propagation delay or a time required for data decoding/encoding. Accordingly, if new data is transmitted after completion of the current HARQ process, there may be a gap in data transmission due to the time delay. To avoid such a gap in data transmission during the time delay, a plurality of independent HARQ processes are used. For example, when there are 7 transmission occasions between initial transmission and retransmission, a communication device may perform data transmission with no gap by managing 7 independent HARQ processes. When the communication device uses a plurality of parallel HARQ processes, the communication device may successively perform UL/DL transmission while waiting for HARQ feedback for previous UL/DL transmission.

In the present disclosure, CSI collectively refers to information indicating the quality of a radio channel (also called a link) created between a UE and an antenna port. The CSI includes at least one of a channel quality indicator (CQI), a precoding matrix indicator (PMI), a CSI-RS resource indicator (CRI), an SSB resource indicator (SSBRI), a layer indicator (LI), a rank indicator (RI), or a reference signal received power (RSRP).

In the present disclosure, frequency division multiplexing (FDM) may mean that signals/channels/users are transmitted/received on different frequency resources, and time division multiplexing (TDM) may mean that signals/channels/users are transmitted/received on different time resources.

In the present disclosure, frequency division duplex (FDD) refers to a communication scheme in which UL communication is performed on a UL carrier and DL communication is performed on a DL carrier linked to the UL carrier, and time division duplex (TDD) refers to a communication scheme in which UL and DL communication are performed by splitting time.

The details of the background, terminology, abbreviations, etc. used herein may be found in documents published before the present disclosure. For example, 3GPP TS 24 series, 3GPP TS 34 series, and 3GPP TS 38 series may be referenced (http://www.3gpp.org/specifications/specification-numbering).

Frame Structure

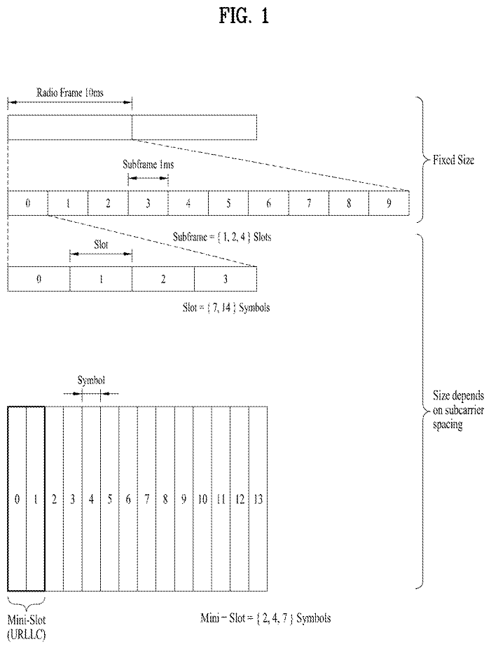

FIG. 1 is a diagram illustrating a frame structure in NR.

The NR system may support multiple numerologies. The numerology is defined by a subcarrier spacing and cyclic prefix (CP) overhead. A plurality of subcarrier spacings may be derived by scaling a basic subcarrier spacing by an integer N (or μ). The numerology may be selected independently of the frequency band of a cell although it is assumed that a small subcarrier spacing is not used at a high carrier frequency. In addition, the NR system may support various frame structures based on the multiple numerologies.

Hereinafter, an OFDM numerology and a frame structure, which may be considered in the NR system, will be described. Table 1 shows multiple OFDM numerologies supported in the NR system. The value of μ for a bandwidth part and a CP may be obtained by RRC parameters provided by the BS.

TABLE 1

| μ | Δf = 2^{μ}*15 [kHz] | Cyclic prefix(CP) |
|---|---|---|
| 0 | 15 | Normal |
| 1 | 30 | Normal |
| 2 | 60 | Normal, Extended |
| 3 | 120 | Normal |
| 4 | 240 | Normal |

The NR system supports multiple numerologies (e.g., subcarrier spacings) to support various 5G services. For example, the NR system supports a wide area in conventional cellular bands in a subcarrier spacing of 15 kHz and supports a dense urban environment, low latency, and wide carrier BW in a subcarrier spacing of 30/60 kHz. In a subcarrier spacing of 60 kHz or above, the NR system supports a BW higher than 24.25 GHz to overcome phase noise.

Resource Grid

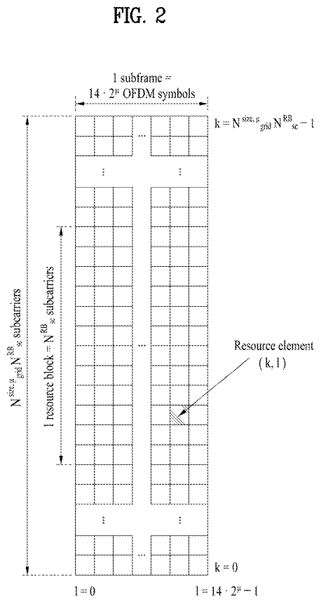

FIG. 2 illustrates a resource grid in the NR.

Referring to FIG. 2, a resource grid consisting of N^{size,μ}grid*N^{RB}_{sc} subcarriers and 142^{μ} OFDM symbols may be defined for each subcarrier spacing configuration and carrier, where N^{size,μ}grid is indicated by RRC signaling from the BS. N^{size,μ}grid may vary not only depending on the subcarrier spacing configuration μ but also between UL and DL. One resource grid exists for the subcarrier spacing configuration μ, an antenna port p, and a transmission direction (i.e., UL or DL). Each element in the resource gird for the subcarrier spacing configuration μ and the antenna port p may be referred to as a resource element and identified uniquely by an index pair of (k, l), where k denotes an index in the frequency domain and l denotes the relative location of a symbol in the frequency domain with respect to a reference point. The resource element (k, l) for the subcarrier spacing configuration μ and the antenna port p may be a physical resource and a complex value, a^{(p,μ)}k,l. A resource block (RB) is defined as N^{RB}_{sc} consecutive subcarriers in the frequency domain (where N^{RB}_{sc}=12).

Considering the point that the UE is incapable of supporting a wide BW supported in the NR system, the UE may be configured to operate in a part of the frequency BW of a cell (hereinafter referred to as a bandwidth part (BWP)).

Bandwidth Part (BWP)

The NR system may support up to 400 MHz for each carrier. If the UE always keeps a radio frequency (RF) module on for all carriers while operating on such a wideband carrier, the battery consumption of the UE may increase. Considering multiple use cases (e.g., eMBB, URLLC, mMTC, V2X, etc.) operating in one wideband carrier, a different numerology (e.g., subcarrier spacing) may be supported for each frequency band of the carrier. Further, considering that each UE may have a different capability regarding the maximum BW, the BS may instruct the UE to operate only in a partial BW rather than the whole BW of the wideband carrier. The partial bandwidth is referred to as the BWP. The BWP is a subset of contiguous common RBs defined for numerology μi in BWP i of the carrier in the frequency domain, and one numerology (e.g., subcarrier spacing, CP length, and/or slot/mini-slot duration) may be configured for the BWP.

The BS may configure one or more BWPs in one carrier configured for the UE. Alternatively, if UEs are concentrated in a specific BWP, the BS may move some UEs to another BWP for load balancing. For frequency-domain inter-cell interference cancellation between neighbor cells, the BS may configure BWPs on both sides of a cell except for some central spectra in the whole BW in the same slot. That is, the BS may configure at least one DL/UL BWP for the UE associated with the wideband carrier, activate at least one of DL/UL BWP(s) configured at a specific time (by L1 signaling which is a physical-layer control signal, a MAC control element (CE) which is a MAC-layer control signal, or RRC signaling), instruct the UE to switch to another configured DL/UL BWP (by L1 signaling, a MAC CE, or RRC signaling), or set a timer value and switch the UE to a predetermined DL/UL BWP upon expiration of the timer value. In particular, an activated DL/UL BWP is referred to as an active DL/UL BWP. While performing initial access or before setting up an RRC connection, the UE may not receive a DL/UL BWP configuration. A DL/UL BWP that the UE assumes in this situation is referred to as an initial active DL/UL BWP.

Synchronization Acquisition of Sidelink UE

In time division multiple access (TDMA) and frequency division multiple access (FDMA) systems, accurate time and frequency synchronization is essential. If time and frequency synchronization is not accurate, inter-symbol interference (ISI) and inter-carrier interference (ICI) may occur so that system performance may be degraded. This may occur in V2X. For time/frequency synchronization in V2X, a sidelink synchronization signal (SLSS) may be used in the physical layer, and master information block-sidelink-V2X (MIB-SL-V2X) may be used in the RLC layer.

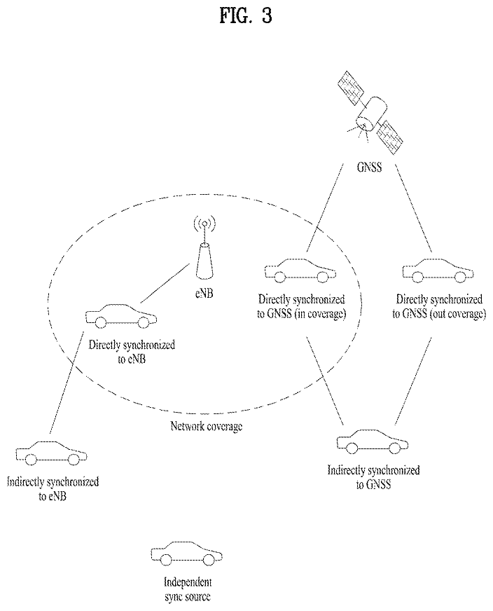

FIG. 3 illustrates a synchronization source and a synchronization reference in V2X.

Referring to FIG. 3, in V2X, a UE may be directly synchronized to global navigation satellite systems (GNSS) or indirectly synchronized to the GNSS through another UE (in or out of the network coverage) that is directly synchronized to the GNSS. When the GNSS is set to the synchronization source, the UE may calculate a direct frame number (DFN) and a subframe number based on coordinated universal time (UTC) and a (pre)configured DFN offset.

Alternatively, the UE may be directly synchronized to the BS or synchronized to another UE that is time/frequency synchronized to the BS. For example, if the UE is in the coverage of the network, the UE may receive synchronization information provided by the BS and be directly synchronized to the BS. Thereafter, the UE may provide the synchronization information to another adjacent UE. If the timing of the BS is set to the synchronization reference, the UE may follow a cell associated with a corresponding frequency (if the UE is in the cell coverage at the corresponding frequency) or follow a Pcell or serving cell (if the UE is out of the cell coverage at the corresponding frequency) for synchronization and DL measurement.

The serving cell (BS) may provide a synchronization configuration for carriers used in V2X sidelink communication. In this case, the UE may follow the synchronization configuration received from the BS. If the UE detects no cell from the carriers used in the V2X sidelink communication and receives no synchronization configuration from the serving cell, the UE may follow a predetermined synchronization configuration.

Alternatively, the UE may be synchronized to another UE that fails to directly or indirectly obtain the synchronization information from the BS or GNSS. The synchronization source and preference may be preconfigured for the UE or configured in a control message from the BS.

Hereinbelow, the SLSS and synchronization information will be described.

The SLSS may be a sidelink-specific sequence and include a primary sidelink synchronization signal (PSSS) and a secondary sidelink synchronization signal (SSSS).

Each SLSS may have a physical layer sidelink synchronization identity (ID), and the value may be, for example, any of 0 to 335. The synchronization source may be identified depending on which of the above values is used. For example, 0, 168, and 169 may indicate the GNSS, 1 to 167 may indicate the BS, and 170 to 335 may indicate out-of-coverage. Alternatively, among the values of the physical layer sidelink synchronization ID, 0 to 167 may be used by the network, and 168 to 335 may be used for the out-of-coverage state.

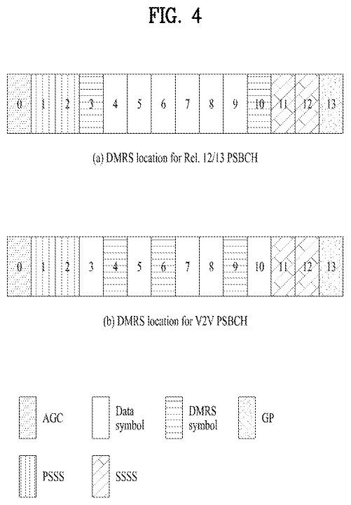

FIG. 4 illustrates a time resource unit for SLSS transmission. The time resource unit may be a subframe in LTE/LTE-A and a slot in 5G. The details may be found in 3GPP TS 36 series or 3GPP TS 28 series. A physical sidelink broadcast channel (PSBCH) may refer to a channel for carrying (broadcasting) basic (system) information that the UE needs to know before sidelink signal transmission and reception (e.g., SLSS-related information, a duplex mode (DM), a TDD UL/DL configuration, information about a resource pool, the type of an SLSS-related application, a subframe offset, broadcast information, etc.). The PSBCH and SLSS may be transmitted in the same time resource unit, or the PSBCH may be transmitted in a time resource unit after that in which the SLSS is transmitted. A DMRS may be used to demodulate the PSBCH.

Sidelink Transmission Mode

For sidelink communication, transmission modes 1, 2, 3 and 4 are used.

In transmission mode 1/3, the BS performs resource scheduling for UE 1 over a PDCCH (more specifically, DCI) and UE 1 performs D2D/V2X communication with UE 2 according to the corresponding resource scheduling. After transmitting sidelink control information (SCI) to UE 2 over a physical sidelink control channel (PSCCH), UE 1 may transmit data based on the SCI over a physical sidelink shared channel (PSSCH). Transmission modes 1 and 3 may be applied to D2D and V2X, respectively.

Transmission mode 2/4 may be a mode in which the UE performs autonomous scheduling (self-scheduling). Specifically, transmission mode 2 is applied to D2D. The UE may perform D2D operation by autonomously selecting a resource from a configured resource pool. Transmission mode 4 is applied to V2X. The UE may perform V2X operation by autonomously selecting a resource from a selection window through a sensing process. After transmitting the SCI to UE 2 over the PSCCH, UE 1 may transmit data based on the SCI over the PSSCH. Hereinafter, the term ‘transmission mode’ may be simply referred to as ‘mode’.

Control information transmitted by a BS to a UE over a PDCCH may be referred to as DCI, whereas control information transmitted by a UE to another UE over a PSCCH may be referred to as SCI. The SCI may carry sidelink scheduling information. The SCI may have several formats, for example, SCI format 0 and SCI format 1.

SCI format 0 may be used for scheduling the PSSCH. SCI format 0 may include a frequency hopping flag (1 bit), a resource block allocation and hopping resource allocation field (the number of bits may vary depending on the number of sidelink RBs), a time resource pattern (7 bits), a modulation and coding scheme (MCS) (5 bits), a time advance indication (11 bits), a group destination ID (8 bits), etc.

SCI format 1 may be used for scheduling the PSSCH. SCI format 1 may include a priority (3 bits), a resource reservation (4 bits), the location of frequency resources for initial transmission and retransmission (the number of bits may vary depending on the number of sidelink subchannels), a time gap between initial transmission and retransmission (4 bits), an MCS (5 bits), a retransmission index (1 bit), a reserved information bit, etc. Hereinbelow, the term ‘reserved information bit’ may be simply referred to as ‘reserved bit’. The reserved bit may be added until the bit size of SCI format 1 becomes 32 bits.

SCI format 0 may be used for transmission modes 1 and 2, and SCI format 1 may be used for transmission modes 3 and 4.

Sidelink Resource Pool

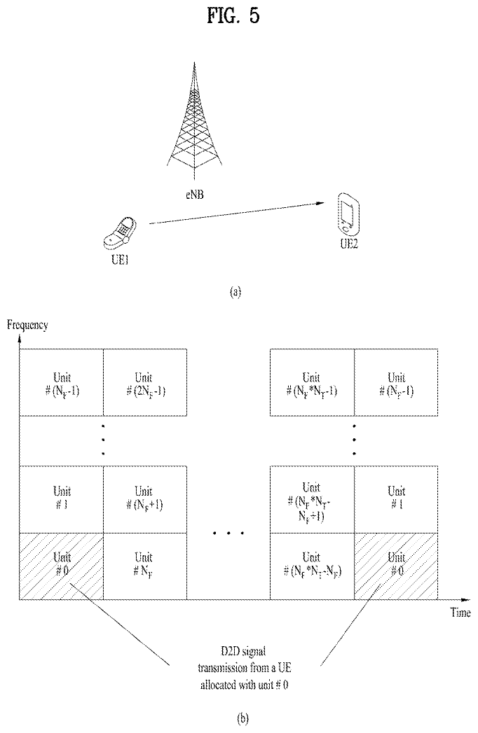

FIG. 5 shows an example of a first UE (UE1), a second UE (UE2) and a resource pool used by UE1 and UE2 performing sidelink communication.

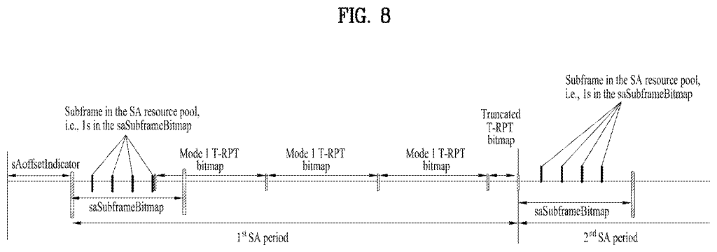

In FIG. 5(a), a UE corresponds to a terminal or such a network device as a BS transmitting and receiving a signal according to a sidelink communication scheme. A UE selects a resource unit corresponding to a specific resource from a resource pool corresponding to a set of resources and the UE transmits a sidelink signal using the selected resource unit. UE2 corresponding to a receiving UE receives a configuration of a resource pool in which UE1 is able to transmit a signal and detects a signal of UE1 in the resource pool. In this case, if UE1 is located in the coverage of a BS, the BS may inform UE1 of the resource pool. If UE1 is located out of the coverage of the BS, the resource pool may be informed by a different UE or may be determined by a predetermined resource. In general, a resource pool includes a plurality of resource units. A UE selects one or more resource units from among a plurality of the resource units and may be able to use the selected resource unit(s) for sidelink signal transmission. FIG. 5(b) shows an example of configuring a resource unit. Referring to FIG. 8(b), the entire frequency resources are divided into the NF number of resource units and the entire time resources are divided into the NT number of resource units. In particular, it is able to define NF*NT number of resource units in total. In particular, a resource pool may be repeated with a period of NT subframes. Specifically, as shown in FIG. 8, one resource unit may periodically and repeatedly appear. Or, an index of a physical resource unit to which a logical resource unit is mapped may change with a predetermined pattern according to time to obtain a diversity gain in time domain and/or frequency domain. In this resource unit structure, a resource pool may correspond to a set of resource units capable of being used by a UE intending to transmit a sidelink signal.

A resource pool may be classified into various types. First of all, the resource pool may be classified according to contents of a sidelink signal transmitted via each resource pool. For example, the contents of the sidelink signal may be classified into various signals and a separate resource pool may be configured according to each of the contents. The contents of the sidelink signal may include a scheduling assignment (SA or physical sidelink control channel (PSCCH)), a sidelink data channel, and a discovery channel. The SA may correspond to a signal including information on a resource position of a sidelink data channel, information on a modulation and coding scheme (MCS) necessary for modulating and demodulating a data channel, information on a MIMO transmission scheme, information on a timing advance (TA), and the like. The SA signal may be transmitted on an identical resource unit in a manner of being multiplexed with sidelink data. In this case, an SA resource pool may correspond to a pool of resources that an SA and sidelink data are transmitted in a manner of being multiplexed. The SA signal may also be referred to as a sidelink control channel or a physical sidelink control channel (PSCCH). The sidelink data channel (or, physical sidelink shared channel (PSSCH)) corresponds to a resource pool used by a transmitting UE to transmit user data. If an SA and a sidelink data are transmitted in a manner of being multiplexed in an identical resource unit, sidelink data channel except SA information may be transmitted only in a resource pool for the sidelink data channel. In other word, REs, which are used to transmit SA information in a specific resource unit of an SA resource pool, may also be used for transmitting sidelink data in a sidelink data channel resource pool. The discovery channel may correspond to a resource pool for a message that enables a neighboring UE to discover transmitting UE transmitting information such as ID of the UE, and the like.

Despite the same contents, sidelink signals may use different resource pools according to the transmission and reception properties of the sidelink signals. For example, despite the same sidelink data channels or the same discovery messages, they may be distinguished by different resource pools according to transmission timing determination schemes for the sidelink signals (e.g., whether a sidelink signal is transmitted at the reception time of a synchronization reference signal or at a time resulting from applying a predetermined TA to the reception time of the synchronization reference signal), resource allocation schemes for the sidelink signals (e.g., whether a BS configures the transmission resources of an individual signal for an individual transmitting UE or the individual transmitting UE autonomously selects the transmission resources of an individual signal in a pool), the signal formats of the sidelink signals (e.g., the number of symbols occupied by each sidelink signal in one subframe or the number of subframes used for transmission of a sidelink signal), signal strengths from the BS, the transmission power of a sidelink UE, and so on. In sidelink communication, a mode in which a BS directly indicates transmission resources to a sidelink transmitting UE is referred to as sidelink transmission mode 1, and a mode in which a transmission resource area is preconfigured or the BS configures a transmission resource area and the UE directly selects transmission resources is referred to as sidelink transmission mode 2. In sidelink discovery, a mode in which a BS directly indicates resources is referred to as Type 2, and a mode in which a UE selects transmission resources directly from a preconfigured resource area or a resource area indicated by the BS is referred to as Type 1.

In V2X, sidelink transmission mode 3 based on centralized scheduling and sidelink transmission mode 4 based on distributed scheduling are available.

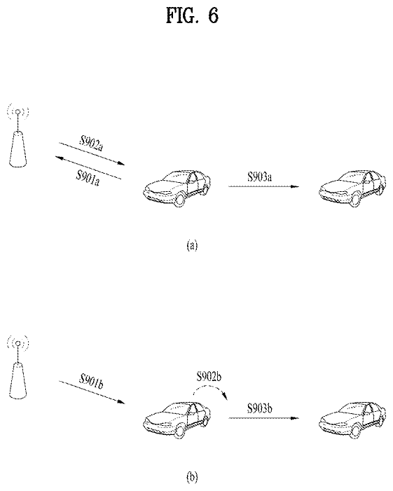

FIG. 6 illustrates scheduling schemes based on these two transmission modes. Referring to FIG. 6, in transmission mode 3 based on centralized scheduling of FIG. 6(a), a vehicle requests sidelink resources to a BS (S901a), and the BS allocates the resources (S902a). Then, the vehicle transmits a signal on the resources to another vehicle (S903a). In the centralized transmission, resources on another carrier may also be scheduled. In transmission mode 4 based on distributed scheduling of FIG. 6(b), a vehicle selects transmission resources (S902b) by sensing a resource pool, which is preconfigured by a BS (S901b). Then, the vehicle may transmit a signal on the selected resources to another vehicle (S903b).

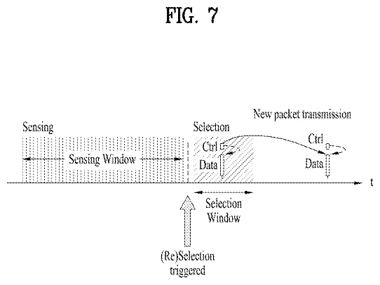

When the transmission resources are selected, transmission resources for a next packet are also reserved as illustrated in FIG. 7. In V2X, transmission is performed twice for each MAC PDU. When resources for initial transmission are selected, resources for retransmission are also reserved with a predetermined time gap from the resources for the initial transmission. The UE may identify transmission resources reserved or used by other UEs through sensing in a sensing window, exclude the transmission resources from a selection window, and randomly select resources with less interference from among the remaining resources.

For example, the UE may decode a PSCCH including information about the cycle of reserved resources within the sensing window and measure PSSCH RSRP on periodic resources determined based on the PSCCH. The UE may exclude resources with PSCCH RSRP more than a threshold from the selection window. Thereafter, the UE may randomly select sidelink resources from the remaining resources in the selection window.

Alternatively, the UE may measure received signal strength indication (RSSI) for the periodic resources in the sensing window and identify resources with less interference, for example, the bottom 20 percent. After selecting resources included in the selection window from among the periodic resources, the UE may randomly select sidelink resources from among the resources included in the selection window. For example, when PSCCH decoding fails, the above method may be applied.

The details thereof may be found in clause 14 of 3GPP TS 3GPP TS 36.213 V14.6.0, which are incorporated herein by reference.

Transmission and Reception of PSCCH

In sidelink transmission mode 1, a UE may transmit a PSCCH (sidelink control signal, SCI, etc.) on a resource configured by a BS. In sidelink transmission mode 2, the BS may configure resources used for sidelink transmission for the UE, and the UE may transmit the PSCCH by selecting a time-frequency resource from among the configured resources.

FIG. 8 shows a PSCCH period defined for sidelink transmission mode 1 or 2.

Referring to FIG. 8, a first PSCCH (or SA) period may start in a time resource unit apart by a predetermined offset from a specific system frame, where the predetermined offset is indicated by higher layer signaling. Each PSCCH period may include a PSCCH resource pool and a time resource unit pool for sidelink data transmission. The PSCCH resource pool may include the first time resource unit in the PSCCH period to the last time resource unit among time resource units indicated as carrying a PSCCH by a time resource unit bitmap. In mode 1, since a time-resource pattern for transmission (T-RPT) or a time-resource pattern (TRP) is applied, the resource pool for sidelink data transmission may include time resource units used for actual transmission. As shown in the drawing, when the number of time resource units included in the PSCCH period except for the PSCCH resource pool is more than the number of T-RPT bits, the T-RPT may be applied repeatedly, and the last applied T-RPT may be truncated as many as the number of remaining time resource units. A transmitting UE performs transmission at a T-RPT position of 1 in a T-RPT bitmap, and transmission is performed four times in one MAC PDU.

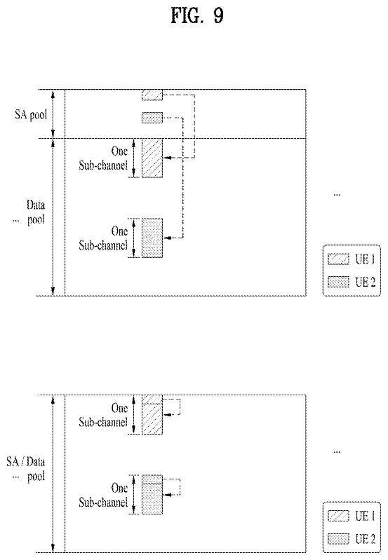

In V2X, that is, sidelink transmission mode 3 or 4, a PSCCH and data (PSSCH) are frequency division multiplexed (FDM) and transmitted, unlike sidelink communication. Since latency reduction is important in V2X in consideration of the nature of vehicle communication, the PSCCH and data are FDM and transmitted on the same time resources but different frequency resources. FIG. 9 illustrates examples of this transmission scheme. The PSCCH and data may not be contiguous to each other as illustrated in FIG. 9(a) or may be contiguous to each other as illustrated in FIG. 9(b). A subchannel is used as the basic unit for the transmission. The subchannel is a resource unit including one or more RBs in the frequency domain within a predetermined time resource (e.g., time resource unit). The number of RBs included in the subchannel, i.e., the size of the subchannel and the starting position of the subchannel in the frequency domain are indicated by higher layer signaling.

In V2V communication, a cooperative awareness message (CAM) of a periodic message type, a decentralized environmental notification message (DENM) of an event triggered message type, and so on may be transmitted. The CAM may deliver basic vehicle information including dynamic state information about a vehicle, such as a direction and a speed, static data of the vehicle, such as dimensions, an ambient illumination state, details of a path, and so on. The CAM may be 50 bytes to 300 bytes in length. The CAM is broadcast, and its latency should be shorter than 100 ms. The DENM may be generated, upon occurrence of an unexpected incident such as breakdown or an accident of a vehicle. The DENM may be shorter than 3000 bytes, and received by all vehicles within a transmission range. The DENM may have a higher priority than the CAM. When it is said that a message has a higher priority, this may mean that from the perspective of one UE, in the case of simultaneous transmission of messages, the higher-priority message is transmitted above all things, or earlier in time than any other of the plurality of messages. From the perspective of multiple UEs, a message having a higher priority may be subjected to less interference than a message having a lower priority, to thereby have a reduced reception error probability. Regarding the CAM, the CAM may have a larger message size when it includes security overhead than when it does not.

Based on the above explanation, the present disclosure proposes a method for a UE to transmit a beam discovery signal in D2D communication.

In conventional millimeter waver (mmWave) systems, a BS transmits multiple types of beams for initial beam search. In addition, a UE obtains system information by discovering the most suitable beam thereamong or performs an initial link setup by transmitting a random access channel (RACH) on the corresponding beam.

However, in D2D communication, since multiple Tx beams are transmitted for initial access to a specific UE and relevant feedback is also provided, significant overhead may be caused. Accordingly, UEs need to avoid performing initial access one-to-one.

Hence, the present disclosure proposes a method of efficiently reducing beam discovery overhead in D2D communication.

Beam Discovery Signal Transmission and Reception Method

According to an embodiment of the present disclosure, a UE may select a beam discovery resource or a beam resource group from a beam discovery resource pool or an initial beam search resource pool. Then, the UE may transmit a beam discovery signal on the beam discovery resource. In this case, the beam discovery resource selected by the UE may be different from a beam discovery resource selected by another UE.

The above-described beam discovery resource pool refers to a resource pool for performing beam discovery for initial transmission between UEs. Here, the beam discovery may mean a procedure in which a UE successfully receives a beam transmitted from a specific UE, measures received signal quality for each beam, or obtains information about the UE transmitting the corresponding beam. The beam discovery may be different from the conventional procedure for discovering a signal between UEs in that a beam type of discovery resource is applied for synchronization between UEs. In particular, in the case of the conventional synchronization signal between UEs, it is impossible to identify each UE signal since a plurality of UEs simultaneously transmit signals on the same resource. However, when the beam discovery resource pool is used, different UEs transmit discovery signals on different resources so that upon receiving the discovery signals, the UE may check which UE uses which beam and enters which state.

The beam discovery resource pool may be divided into beam discovery resources (or beam resource groups). Each beam discovery resource may include a plurality of consecutive beam resources. A beam transmission direction may be allocated to each of the plurality of beam resources, and the beam resources may not overlap in the time domain. In this case, the beam discovery signal may be transmitted on a beam resource among the plurality of beam resources in the directions according to the beam discovery resource in the order of the directions. That is, the UE may transmit different beam discovery signals multiple times on one beam discovery resource.

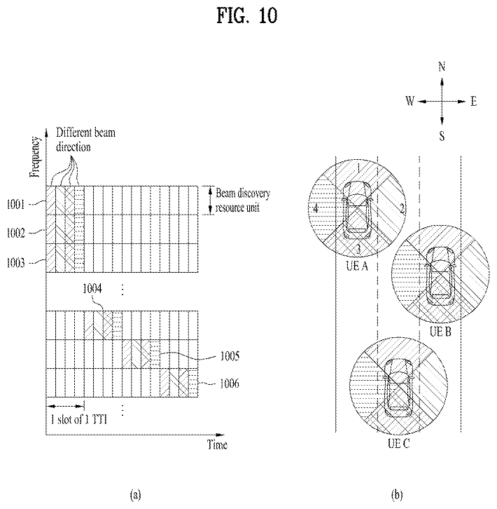

Details will be described with reference to FIG. 10. FIG. 10(a) is a diagram illustrating a configuration in which beam discovery resources and beam resources are included in a beam discovery resource pool according to the present disclosure, and FIG. 10(b) is a diagram illustrating an embodiment in which a UE transmits a beam discovery signal on a beam discovery resource according to the present disclosure.

Referring to FIG. 10(a), there is one beam discovery resource pool, and a plurality of beam discovery resources are present in the beam discovery resource pool. For example, beam discovery resource #0 (1001), beam discovery resource #1 (1002), and beam discovery resource #2 (1003) may exist in the same beam discovery resource pool. In addition, one beam discovery resource may consist of a plurality of beam resources, and each beam resource may correspond to a prescribed time unit (e.g., a slot, a transmission time interval (TTI), a subframe, etc.). The configurations of resources including the beam resource will be described in detail later. The prescribed time unit may be preconfigured or provided by higher layer signaling or physical layer signaling. Each beam discovery resource may be FDM. For example, beam discovery resource #0 (1001), beam discovery resource #1 (1002), and beam discovery resource #2 (1003) may not overlap with each other in the frequency domain.

A beam transmission direction may be allocated to each of the beam resources, that is, the beam resources may have different beam transmission directions. For example, as shown in FIG. 10(a), four beam resources may exist in one beam discovery resource, and a direction may be allocated to each of the beam resources with no overlap. In addition, since beam resources included in the same beam discovery resource do not overlap with each other in the time domain, the beam discovery signal may be transmitted in different directions at different times. Since the UE is capable of transmitting the signal in the directions according to the beam discovery resource in the order of the directions. For example, assuming that the beam transmission directions of north, east, south, and west are respectively allocated to four beam resources included in one beam discovery resource in FIG. 10(a), if the UE selects the beam discovery resource, the UE may transmit the beam discovery signal to other UEs at different times in the following order: north, east, south, and west. Specifically, referring to FIG. 10(b), directions may be divided into four parts: directions #1 to #4, and north, east, south, and west may be allocated clockwise. In this case, UE A may transmit the beam discovery signal in the following order: north, east, south, and west.

The above-described beam discovery resource pool may be configured based on periods, formats, sizes, etc. The network may determine the period of the beam discovery resource pool depending on the state of the UE. Specifically, the network may configure the period of the beam discovery resource pool depending on the moving speed of the UE, the state or type of a road, the location/area of the UE, congestion levels, etc. For example, when a vehicle moves along a highway at a high speed, the period of the beam discovery resource pool may decrease. As another example, when a UE slowly moves in an urban environment, the period of the beam discovery resource pool may increase. Further, the network may be fed back with information about the UE's state to determine the period, type, size, etc. of the beam discovery resource pool depending on the UE's state. For example, when the UE is out of a cell (out-of-coverage), the period, type, size, etc. of the beam discovery resource pool may be predetermined. The period of the beam discovery resource pool may be set to one of the following values: 10 ms, 20 ms, 40 ms, 80 ms, and 160 ms. However, the present disclosure is not limited to the above values.

According to an embodiment of the present disclosure, a resource pool may be a resource unit for transmitting a beam in different directions. The resource pool for beam discovery (or initial beam discovery) resource may correspond to the above-described beam discovery resource pool. In the resource pool, an omni-directional beam or a predetermined number of beams may be transmitted. The resource pool may be preconfigured for the UE, and in this case, time and frequency resources in the resource pool may be predetermined or signaled by the BS. For example, the number of beams transmitted in one resource pool, the time/frequency resource unit for transmitting one beam in the resource pool, the amount of time/frequency resources in the beam discovery resource may be determined by the network or predetermined for the UE. The above configuration may be determined differently or separately for each resource pool.

Since the resource pool for the beam discovery may correspond to the beam discovery resource pool as described above, one resource pool for the beam discovery (or one period for the beam discovery from the perspective of the time domain) may be divided into multiple beam discovery resources. The UE may select a specific beam discovery resource from among multiple beam discovery resources and then transmit the beam discovery signal thereon. The beam discovery signal may be an RS, a packet (carrying specific information that is channel coded/modulated), or a combination of the RS and packet. According to an embodiment of the present disclosure, the UE may receive a signal specifying the beam discovery resource from the BS to select the beam discovery resource. Alternatively, the UE may autonomously select a specific resource group from among multiple resource groups and transmits an RS and/or packet for the beam discovery. Alternatively, the BS may instruct a specific UE to use a specific beam discovery resource through physical layer signaling or higher layer signaling.

The beam discovery resource may include a plurality of consecutive beam resources, and thus the beam discovery signal may be transmitted in different directions on the plurality of beam resources in the beam discovery resource. The beam resources are allocated for different Tx beams. The amount of frequency resources, the number of symbols, etc. in the beam resource used by the UE may be predetermined or signaled by the network through a physical layer or higher layer signal.

Since the beam discovery signal may be transmitted in different directions, a receiving UE may receive beams in complementary directions (i.e., directions in which the beam discovery signal is transmitted) or according to UE implementation. For example, in FIG. 10(b), if a transmitting UE transmits the beam discovery signal in the following direction order: north, east, south, and west, the receiving UE may change the beam reception order as follows: south, west, north, and east. When the direction of the Tx beam is determined as described above, the receiving UE may easily determine how and when to configure the direction of the Rx beam in order to receive the beam discovery signal efficiently from the transmitting UE. In particular, the receiving UE may configure the Rx beam efficiently if the receiving UE is capable of recognizing the approximate location of a peer UE at a low frequency (e.g., 5.9 GHz band). For example, referring to FIG. 10(b), assuming that UE A performs transmission on beam #2 (in the east direction), UE B may not know which one of beam #1 and beam #4 is better. In this case, UE B may receive on beam #1 in a specific beam discovery period and receive on beam #4 in another beam discovery period to determine a better beam as the initial beam. To this end, each transmitting UE may inform neighbor UEs of the currently used beam discovery resource at a low frequency. Upon receiving the information, the receiving UE may determine the beam discovery resource and RX beam to be used based on the approximate relative location of each transmitting UE.

According to the above-described methods, UEs transmitting beam discovery signals are synchronized with each other and change the directions of Tx beams to be the same at the same time. However, as a modification of the method, it may be considered that receiving UEs are synchronized with each other and change the directions of beams to be the same at the same time. In this case, the Tx beam may be configured differently depending on UE implementation, or the direction of the Tx beam may be configured with respect to the Rx beam. Although this method is similar to the above-described methods, it has the following advantages: since UE Rx beams are simultaneously changed, the transmitting UE is capable of determining the direction of the Tx beam for communication with a specific UE at a specific time. Further, according to the proposed method, the UE may obtain appropriate Tx/Rx beam directions for multiple UEs from the beam discovery resource pool without performing any beam scanning processes.

Reference Direction for Transmitting and Receiving Beam Discovery Signal

According to an embodiment of the present disclosure, when transmitting a beam on a beam discovery resource, a UE may transmit in the same direction at a specific time with respect to a specific direction. For example, all UEs may transmit in the same direction at a specific time with respect to the cardinal directions when transmitting beams on beam discovery resources. According to this method, transmitting UEs may transmit beams in the same direction, and receiving UEs may easily determine their Rx beam directions by anticipating the beam directions of other UEs.

As another method, the direction according to the beam discovery resource may be determined based on the moving direction of the UE. Specifically, although all UE may transmit beams at a specific time with respect to only the cardinal directions when transmitting beams on beam discovery resources, the UEs may transmit the beams sequentially with respect to the cardinal directions and the heading angle directions of a vehicle with respect to the cardinal directions or the moving direction of the vehicle. For example, in the case of a road that curves from north to other directions or a curve road (for example, when the moving directions of UEs are not north), beams may be sequentially transmitted with respect to the moving directions of the UEs. According to this method, since it is expected that the moving directions of neighbor UEs are similar to each other, the beams may be efficiently received with no significant errors even if the transmission order of the beams are determined with respect to the moving directions of the UEs. For example, in FIG. 10(b), assuming that UE A, UE B, and UE C moves on a curve road rather than a straight road, there may be a difference between the beam transmission directions of UE A and UE C if the beam transmission directions are determined with respect to only the cardinal directions. In this case, if the beam transmission directions are allocated to beam resources by considering the moving directions of the UEs, the difference between the beam transmission directions of UE A and UE C may become less or zero.

Whether the beam transmission directions of UEs are determined with respect to the cardinal directions or in consideration of the moving directions thereof may be configured by the network. Alternatively, the determination may depend on UE capability. For example, if a UE transmits and receives a basic safety message on 5.9 GHz, the UE may transmit a beam with respect to the cardinal directions. In the case of a UE transmitting and receiving no basic safety message, the UE may transmit a beam with respect to its own moving direction. The network may determine methods suitable for UEs in a specific area by considering the distribution of the UEs and then inform the UEs of the methods through physical layer or higher layer signaling.

Configuration of Beam Discovery Resource Pattern

According to an embodiment of the present disclosure, hopping may prevent beam discovery resources from overlapping with each other in the time domain. That is, beam discovery resources may be configured such that the beam discovery resources are hopped in a beam discovery resource pool. In this case, since the location of a beam discovery resource used by a specific UE may change at every period, it may prevent two specific UEs from continuing the use of the same time unit and not discovering each other. Specifically, each beam discovery resource may have a predetermined hopping pattern in a predetermined resource pool, or a hopping pattern may be randomly determined at every discovery period. In this case, the hopping pattern may solve a half-duplex problem. The UE may determine the beam discovery resource based on sensing. For example, the UE may select the beam discovery resource from among resources having energy less than a prescribed threshold, that is, resources which are assumed to be not used by other neighbor UEs.

As the hopping method for the beam discovery resource, the type 2B hipping method defined in Rel-12 sidelink discovery or the same hopping method as that for a control channel (e.g., PSCCH hopping method defined for Rel-12 sidelink control information transmission) may be adopted. Specifically, FIG. 10(a) shows that beam discovery resources are hopped according to the PSCCH hopping method. Beam discovery resource #0 (1001), beam discovery resource #1 (1002), and beam discovery resource #3 (1002) are transmitted together in the first time unit, but beam discovery resource #0 (1004), beam discovery resource #1 (1005), and beam discovery resource #2 (1006) are transmitted in second and third time units, which are different from the former. Thus, each UE may receive the beam with no half-duplex problem. For example, assuming that UE A transmits the beam discovery signal on beam discovery resource #0 (1004) and UE B transmits the beam discovery signal on beam discovery resource #1 (1005), UE B transmits no beam discovery signal while UE A transmits the beam discovery signal, and thus the beam discovery signal may be received with no half-duplex problem.

When no hopping is applied to beam discovery resources, if UEs selects beam discovery resources from the same beam discovery resource pool, the UEs may simultaneously transmit beam discovery signals in the same directions in the same direction order. That is, referring to FIG. 10(a), since no hopping is applied to beam discovery resource #0 (1001), beam discovery resource #1 (1002), and beam discovery resource #2 (1003), the beam discovery resources are transmitted in the same time unit. In this case, since all UEs using the same beam discovery resource pool transmit signals in the same direction at specific times, the amount of interference may be easily measured for each direction. If it is premised that the SLSS is synchronized between the UEs, the specific times may be the same.

Beam Discovery Signal Transmission Per Zone

According to an embodiment of the present disclosure, a UE may transmit a beam discovery resource for each zone. Specifically, the zone may be determined based on physical locations and/or time/frequency resources. A different beam discovery resource pool may be configured for each zone, and thus, different beam discovery resources and different beam resources may be configured for each zone. Since the beam discovery resource pool varies for each zone, different beam transmission directions may be allocated to multiple beam resources in beam discovery resources in the discovery resource pool. In other words, when UEs belong to different zones, the directions and order thereof for beam discovery signal transmission may vary between the UEs. Thus, interference between zones may be mitigated.

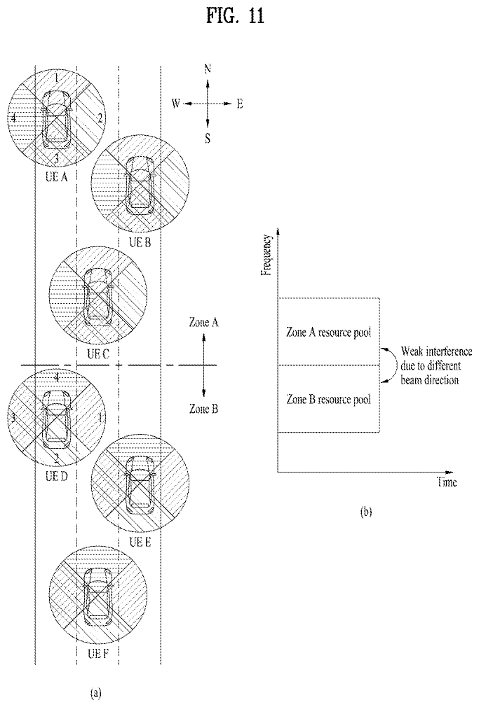

FIG. 11 is a diagram illustrating an embodiment in which a beam discovery resource is transmitted in each different zone according to the present disclosure. FIG. 11(a) illustrates an embodiment in which beam directions and order thereof vary for each zone, and FIG. 11(b) illustrates an embodiment in which different beam discovery resources are configured for each zone.

In FIG. 11(a), UE A, UE B, and UE C are in zone A, and UE D, UE E, and UE F are in zone B. In this case, since UE A, UE B, and UE C are in the same zone, the UEs may select beam discovery resources from the same beam discovery resource pool. Thus, UE A, UE B, and UE C may transmit beam discovery signals in the same beam transmission directions and the same beam transmission direction order. Similarly, since UE D, UE E, and UE F are in the same zone, the UEs may select beam discovery resources from the same beam discovery resource pool. Since the zone for UE A, UE B, and UE C is different from that for UE D, UE E, and UE F, two UE groups transmit beam discovery signals in different beam transmission directions in different beam transmission direction order. Specifically, UE A, UE B, and UE C may be distinguished from UE D, UE E, and UE F depending on the physical positions thereof with respect to the cardinal directions or the moving directions thereof, that is, whether a UE is located behind another UE. Due to the use of different frequency resources, different zones may be used.

Since the zone for UE A, UE B, and UE C is different from that for UE D, UE E, and UE F, interference between groups may be mitigated, and thus the efficiency of signal transmission may be improved. Specifically, FIG. 11 (b) shows a configuration in which the beam discovery resource pool allocated for zone A has a different frequency band from the beam discovery resource pool allocated for zone B. Since different beam discovery resource pools mean different beam transmission directions and different beam transmission direction order, interference between the zones may be mitigated when the discovery signal is transmitted. In the mmWave, since the length of a CP decreases, the CP may not absorb the entirety of a signal from a far UE. In this case, if the zone-based synchronization signal is transmitted and a receiving UE receives by performing a fast Fourier transform (FFT) separately for each zone, the reception may be efficiently performed with no increase in the CP length. When resources in adjacent zones are FDM, inter-channel/carrier interference (ICI) may occur due to different timings. By configuring different beam transmission direction order for each zone, the ICI may be significantly reduced.

Although FIGS. 10 and 11 show that one beam discovery resource includes four beam resources, the beam discovery resource according to the present disclosure is not limited thereto. That is, the beam discovery resource may include multiple beam resources. The number of beams transmitted by the UE in a specific beam discovery resource pool may vary according to the network configuration or UE capability. For example, when the network configures that four beams are transmitted on one beam discovery resource, if a specific UE is capable of transmitting only two beams, the UE may use two beam resources among the four beam resources or repeatedly transmit the two beams.

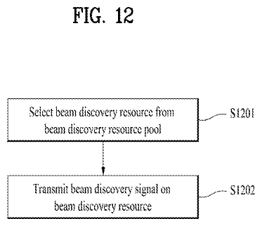

FIG. 12 is a flowchart for explaining an embodiment of the present disclosure. Referring to FIG. 12, a UE according to an embodiment of the present disclosure may select a beam discovery resource from a beam discovery resource pool (S1201) and transmit a beam discovery signal on the beam discovery resource (S1202). The selected beam discovery resource may be different from a beam discovery resource selected by another UE. When selecting the beam discovery resource, the UE may autonomously select the beam discovery resource from among a plurality of beam discovery resources or receive a signal specifying the beam discovery resource from a BS. A UE according to another embodiment of the present disclosure may select a beam discovery resource from a beam discovery resource pool and receive a beam discovery signal on the beam discovery resource. The selected beam discovery resource may be different from a beam discovery resource selected by another UE. When selecting the beam discovery resource, the UE may autonomously select the beam discovery resource from among a plurality of beam discovery resources or receive a signal specifying the beam discovery resource from the BS. The definitions of the beam discovery resource pool, beam discovery resource, and beam resource have been described above.

The beam discovery signal may be transmitted and received in the directions according to the beam discovery resource in the order of the directions. The beam discovery resource may include a plurality of consecutive beam resources. The plurality of beam resources may not overlap with each other in the time domain, and a beam transmission direction may be allocated to each of the plurality of beam resources. The beam discovery signal may be transmitted on one of the plurality of beam resources. Since UEs in the same zone select the beam discovery resource from the same beam discovery resource pool, the UEs may follow the same beam transmission directions and the same direction order. Accordingly, the UEs in the same zone may transmit the beam discovery signal to other UEs in the same beam transmission direction order. On the other hand, since UEs in different zones select the beam discovery resource from different beam discovery resource pools, the UEs may follow different beam transmission directions and different direction order. Hence, the UEs may transmit the beam discovery signal with relatively less interference.

The present disclosure is not limited to D2D communication. That is, the disclosure may be applied to UL or DL communication, and in this case, the proposed methods may be used by a BS, a relay node, etc.

Since each of the examples of the proposed methods may be included as one method for implementing the present disclosure, it is apparent that each example may be regarded as a proposed method. Although the proposed methods may be implemented independently, some of the proposed methods may be combined (or merged) for implementation. In addition, it may be regulated that information on whether the proposed methods are applied (or information on rules related to the proposed methods) should be transmitted from a BS to a UE or from a transmitting UE to a receiving UE through a predefined signal (e.g., a physical layer signal, a higher layer signal, etc.).

Device Configurations According to Embodiments of the Present Disclosure

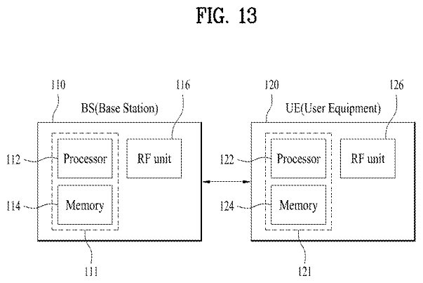

FIG. 13 is a diagram illustrating devices according to the present disclosure. Referring to FIG. 13, a wireless communication system includes a BS 110 and a UE 120. When the wireless communication system includes a relay, the BS or UE may be replaced with the relay.

The BS 110 may include a processor 112, a memory 114, and a radio frequency (RF) unit 116. The processor 112 may be configured to perform the described/proposed procedures and methods by controlling the memory 114 and/or the RF unit 116. For example, the processor 112 may generate first information and/or a first signal by processing information in the memory 114 and then control the RF unit 116 to transmit a radio signal containing the first information/signal. The processor 112 may control the RF unit 116 to receive a radio signal containing second information and/or a second signal and then control the memory 114 to store information obtained by processing the second information/signal. The processor 112 may include a communication modem designed suitable for a wireless communication technology (e.g., LTE, NR, etc.). The memory 114 may be connected to the processor 112 and configured to store various information on the operations of the processor 112. For example, the memory 114 may store software code including commands for performing some or all of the processes controlled by the processor 112 or the described/proposed procedures and methods. The RF unit 116 may be connected to the processor 112 and configured to transmit and/or receive a radio signal. The RF unit 116 may include a transmitter and/or a receiver. The RF unit 116 may be replaced with a transceiver. The processor 112 and the memory 114 may be included in a processing chip 111 (e.g., system on chip (SOC)).

The UE 120 may include a processor 122, a memory 124, and an RF unit 126. The processor 122 may be configured to perform the described/proposed procedures and methods by controlling the memory 124 and/or the RF unit 126. For example, the processor 122 may generate third information or a third signal by processing information in the memory 124 and then control the RF unit 126 to transmit a radio signal containing the third information/signal. The processor 122 may control the RF unit 126 to receive a radio signal containing fourth information or a fourth signal and then control the memory 124 to store information obtained by processing the fourth information/signal.

For example, the processor 112 may be configured to select a beam discovery resource from a beam discovery resource pool and transmit a beam discovery signal on the beam discovery resource. In this case, the selected beam discovery resource may be different from a beam discovery resource selected by another UE.

The processor 122 may include a communication modem designed suitable for a wireless communication technology (e.g., LTE, NR, etc.). The memory 124 may be connected to the processor 122 and configured to store various information on the operations of the processor 122. For example, the memory 124 may store software code including commands for performing some or all of the processes controlled by the processor 122 or the described/proposed procedures and methods. The RF unit 126 may be connected to the processor 122 and configured to transmit and/or receive a radio signal. The RF unit 126 may include a transmitter and/or a receiver. The RF unit 126 may be replaced with a transceiver. The processor 122 and the memory 124 may be included in a processing chip 121 (e.g., SOC).

The above-described embodiments are combinations of elements and features of the present disclosure in prescribed forms. The elements or features may be considered as selective unless specified otherwise. Each element or feature may be implemented without being combined with other elements or features. Further, the embodiment of the present disclosure may be constructed by combining some of the elements and/or features. The order of the operations described in the embodiments of the present disclosure may be modified. Some configurations or features of any one embodiment may be included in another embodiment or replaced with corresponding configurations or features of the other embodiment. It is obvious to those skilled in the art that claims that are not explicitly cited in each other in the appended claims may be presented in combination as an embodiment of the present disclosure or included as a new claim by a subsequent amendment after the application is filed.

In this document, the embodiments of the present disclosure are mainly described based on a signal transmission and reception relationship between the BS and UE. The signal transmission and reception relationship may be equally/similarly applied to signal transmission between the UE and relay or signal transmission between the BS and relay. A specific operation described as performed by the BS may be performed by an upper node of the BS. That is, it is apparent that various operations for communication with the UE may be performed by the BS or other network nodes rather than the BS in a network including a plurality of network nodes including the BS. The term ‘base station’ may be replaced with ‘fixed station’, ‘Node B’, ‘eNode B (eNB)’, ‘gNode B (gNB)’, ‘access point (AP)’, etc. The term ‘terminal’ may be replaced with ‘user equipment (UE)’, ‘mobile station (MS)’, ‘mobile subscriber station (MSS)’, etc.

The embodiments of the present disclosure may be achieved by various means, for example, hardware, firmware, software, or any combination thereof. In a hardware configuration, the embodiments of the present disclosure may be achieved by at least one of application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In a firmware or software configuration, the embodiments of the present disclosure may be implemented in the form of a module, a procedure, a function, etc. for performing the above-described functions or operations. Software code may be stored in the memory and executed by the processor. The memory is located at the interior or exterior of the processor and may transmit and receive data to and from the processor via various known means.

Those skilled in the art will appreciate that the present disclosure may be carried out in other specific ways than those set forth herein without departing from the essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

The above-described embodiments of the present disclosure are applicable to various mobile communication systems.

1. A method of transmitting a beam discovery signal by a user equipment (UE) in a wireless communication system, the method comprising:
selecting, by a first UE obtaining sidelink synchronization, a beam discovery resource from a beam discovery resource pool; and
transmitting the beam discovery signal on the selected beam discovery resource,
wherein the selected beam discovery resource is different from a beam discovery resource selected by a second UE.

2. The method of claim 1, wherein to select the beam discovery resource, the first UE selects one beam discovery resource from among a plurality of beam discovery resources.

3. The method of claim 1, wherein to select the beam discovery resource, the first UE receives signaling specifying the beam discovery resource from a base station.

4. The method of claim 1, wherein the beam discovery signal is transmitted in directions according to the beam discovery resource in order of the directions.

5. The method of claim 1, wherein the beam discovery resource includes a plurality of consecutive beam resources, wherein the plurality of beam resources do not overlap with each other in a time domain, and wherein a beam transmission direction is allocated to each of the plurality of beam resources.

6. The method of claim 5, wherein the first and second UEs belong to different zones.

7. The method of claim 6, wherein the beam transmission direction allocated to each of the plurality of beam resources varies for each zone.

8. The method of claim 5, wherein the beam discovery signal is transmitted on a beam resource among the plurality of beam resources.

9. The method of claim 4, wherein the directions according to the beam discovery resource are determined with respect to cardinal directions.

10. The method of claim 9, wherein the directions according to the beam discovery resource are determined with respect to a moving direction of the first UE.

11. The method of claim 1, wherein the beam discovery resource is configured to be hopped in the beam discovery resource pool.

12. The method of claim 11, wherein the beam discovery resource is hopped in a same way as hopping on a control channel.

13. The method of claim 1, wherein the beam discovery resource pool is configured with a period determined by a base station depending on a state of the UE.

14. A method of receiving a beam discovery signal by a user equipment (UE) in a wireless communication system, the method comprising:
selecting, by a first UE obtaining sidelink synchronization, a beam discovery resource from a beam discovery resource pool; and
receiving the beam discovery signal on the selected beam discovery resource,
wherein the selected beam discovery resource is different from a beam discovery resource selected by a second UE.

15. A first user equipment (UE) device for transmitting a beam discovery signal in a wireless communication system, the first UE device comprising:
a transceiver; and
a processor configured to control the transceiver,
wherein the processor is configured to:
obtain sidelink synchronization to select a beam discovery resource from a beam discovery resource pool; and
transmit the beam discovery signal on the selected beam discovery resource, and
wherein the selected beam discovery resource is different from a beam discovery resource selected by a second UE.

16. The UE according to claim 15, wherein the UE is capable of communicating with at least one of another UE, a UE related to an autonomous driving vehicle, a base station or a network.
